(19) United States
(12) Patent Application Publication
(10) Pub. No.: US 2016/0204484 A1
(43) Pub. Date: Jul. 14, 2016

(54) ENERGY STORAGE DEVICE HEATING SYSTEM AND METHOD

(71) Applicant: COOPER TECHNOLOGIES COMPANY, Houston, TX (US)

(72) Inventors: Gregg James Haensgen, Menomonee Falls, WI (US); Denis Sterjo, Cudahy, WI (US); Kyle Heiden, Milwaukee, WI (US); Richard William Lucas, Zimmerman, MN (US)

(73) Assignee: COOPER TECHNOLOGIES COMPANY, Houston, TX (US)

(21) Appl. No.: 14/593,280

(22) Filed: Jan. 9, 2015

(51) Int. Cl. H01M 10/637; H02J 7/00

(52) U.S. Cl. CPC H01M 10/637; H02J 7/0068; H02J 7/0072

(57) ABSTRACT

An energy storage device heating system includes an energy storage device, a power supply structured to generate a source of harvested energy by harvesting energy from a power source, a heater disposed proximate to the energy storage device and structured to use the harvested energy to generate heat, a charging unit structured to use the harvested energy to charge the energy storage device, a selection circuit structured to selectively electrically connect the source of harvested energy to the charging unit or the heater, and a control unit including a selection control module structured to control the selection circuit to switch between electrically connecting the source of harvested energy to the charging unit and electrically connecting the source of harvested energy to the heater.

### BACKGROUND

1. Field

The disclosed concept relates generally to batteries, and in particular, to energy storage device heating systems and methods.

2. Background Information

Batteries are one type of energy storage device. Batteries convert stored chemical energy into electrical energy. Some types of batteries are rechargeable, and passing a current through the battery allows the battery to be recharged.

Batteries are used in a variety of environments. However, as with many types of electrical devices, extreme temperatures can hinder the performance of batteries. For example, in colder environments (e.g., below −10° C.) some types of batteries will not recharge properly, nor are they able to deliver higher currents. In order to prevent the temperature of the battery from falling too much, some battery systems have incorporated heaters that generate heat to increase the temperature of the battery.

High temperatures can also hinder performance of a battery, as well as cause safety concerns such as melting components or starting fires. In battery systems that incorporate heaters, high temperatures caused by the heater are a concern. If the heater is permitted to heat the battery without restraint, the temperature of the battery can get too high. In order to prevent the temperature of the battery from getting too high, existing battery systems have included a temperature sensor proximate to the battery to sense the temperature of the battery. The output of the temperature sensor is used to turn off the heater when the temperature of the battery gets too high. However, a temperature sensor for the battery adds to the cost of the battery system.

In existing battery systems, energy to operate the heater is provided from the battery itself. Using power from the battery to provide heating can shorten the lifespan or the discharge cycle of the battery.

There is room for improvement in energy storage device heating systems.

### SUMMARY

These needs and others are met by embodiments of the disclosed concept in which an energy storage device heating system includes a power supply structured to harvest energy from a power source and a selection circuit structured to provide the harvested energy to either a charging unit to charge an energy storage device or a heater to heat the energy storage device.

In accordance with one aspect of the disclosed concept, an energy storage device heating system comprises: an energy storage device; a power supply structured to generate a source of harvested energy by harvesting energy from a power source; a heater disposed proximate to the energy storage device and structured to use the harvested energy to generate heat; a charging unit structured to use the harvested energy to charge the energy storage device; a selection circuit structured to selectively electrically connect the source of harvested energy to the charging unit or the heater; and a control unit including a selection control module structured to control the selection circuit to switch between electrically connecting the source of harvested energy to the charging unit and electrically connecting the source of harvested energy to the heater.

In accordance with another aspect of the disclosed concept, an energy storage device heating system comprises: an energy storage device; a power supply structured to generate a source of harvested energy by harvesting energy from a power source; a heater disposed proximate to the energy storage device and structured to use the harvested energy to generate heat; a selection circuit structured to selectively electrically connect the source of harvested energy to the heater or to electrically disconnect the source of harvested energy from the heater; and a control unit including a selection control module structured to control the selection circuit to switch between electrically connecting the source of harvested energy to the heater and electrically disconnecting the source of harvested energy from the heater.

In accordance with another aspect of the disclosed concept, a method of heating an energy storage device comprises: creating a source of harvested energy by harvesting energy from a power source; and for a selected period of time, electrically connecting the source of harvested energy to a heater to heat the battery for a first percentage of the selected period of time and electrically connecting the source of harvested energy to a charging unit to charge the energy storage device then remainder of the selected period of time.

### BRIEF DESCRIPTION OF THE DRAWINGS

A full understanding of the disclosed concept can be gained from the following description of the preferred embodiments when read in conjunction with the accompanying drawings in which:

FIG. 1 is a schematic diagram of a battery heating system in accordance with an example embodiment of the disclosed concept;

FIG. 2 is a schematic diagram of a battery heating system in accordance with another example embodiment of the disclosed concept;

FIG. 3 is a circuit diagram of the battery heating system of FIG. 2;

FIG. 4 is a circuit diagram of a heater including multiple resistive loads in accordance with an example embodiment of the disclosed concept; and

FIG. 5 is a battery heating system in accordance with another example embodiment of the disclosed concept.

### DESCRIPTION OF THE PREFERRED EMBODIMENTS

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

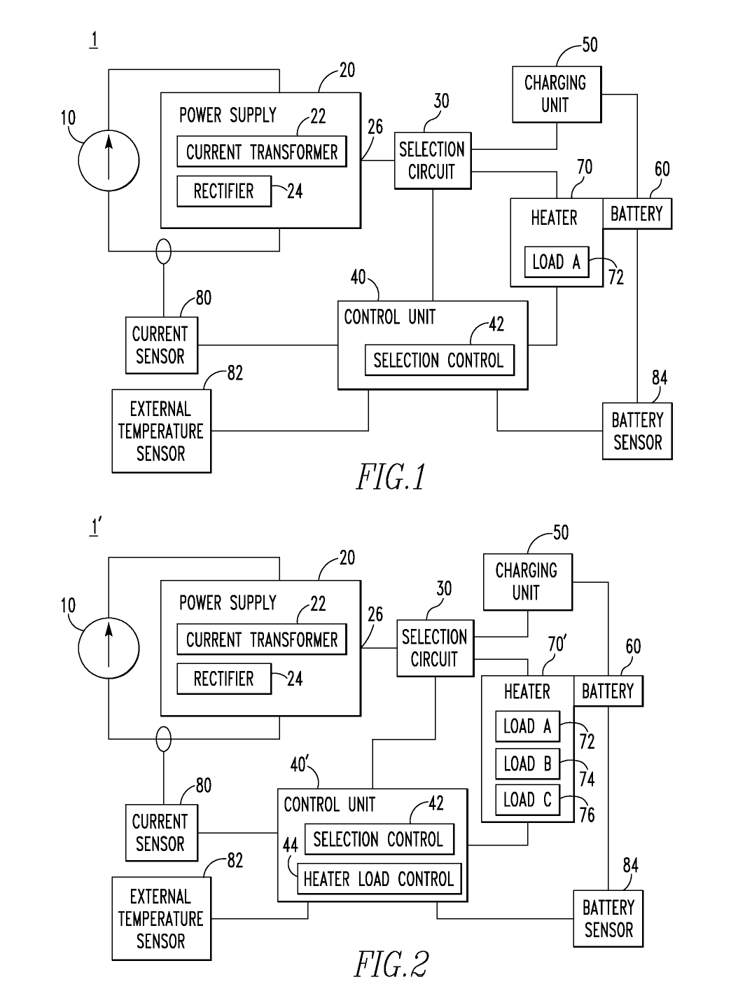

A schematic diagram of a battery heating system 1 in accordance with an example embodiment of the disclosed concept is shown in FIG. 1. The battery heating system 1 includes a power supply 20, a selection circuit 30, a control unit 40, a charging unit 50, a battery 60, and a heater 70.

The power supply 20 is structured to harvest energy from a power source such as a line current 10. The power supply 20 includes a current transformer 22 that is structured to inductively couple with the line to harvest energy from the line current 10. The power supply 20 also includes a rectifier 24. The rectifier 24 is electrically connected to the current transformer 22 and rectifies the harvested energy (i.e., changes the harvested energy from AC power to DC power) from the current transformer 24. After it is rectified, the harvested energy from the power supply 20 is provided to the selection circuit 30. The output of the power supply 20 effectively operates as a source of harvested energy 26.

Although a line current 10 is described and shown in relation to FIG. 1, it is contemplated that other types of power sources may be employed in conjunction with the disclosed concept. For example and without limitation, solar, wind, biological, mechanical, or any other type of suitable power source may be employed in conjunction with the disclosed concept. If a different type of power source is employed, it is contemplated that the power supply 20 may be modified to suitably harvest energy from the power source without departing from the scope of the disclosed concept.

The selection circuit 30 is structured to receive the harvested energy from the source of harvested energy 26 and to supply it to either the charging unit 50 or the heater 70. At any given time, the selection circuit 30 provides the harvested energy to the charging unit 50 or the heater 70 by electrically connecting the source of harvested energy 26 to the charging unit 50 or the heater 70, but the selection circuit 30 does not electrically connect the source of harvested energy 26 to both the charging unit 50 and the heater 70 at the same time.

In some embodiments of the disclosed concept, the selection circuit 30 includes a number of electrically controlled switches (e.g., without limitation, transistors) that are electrically connected between the power supply 20 and the charging unit 50 or the heater 70. The electrically controlled switches are structured to electrically connect the source of harvested energy 26 to the charging unit 50 or the heater 70 when closed, or to electrically disconnect the source of harvested energy 26 from the charging unit 50 or the heater 70 when open. The electrically controlled switches are controlled by the control unit 40.

The charging unit 50 is structured to use the harvested energy to charge the battery 60. The charging unit 50 may be any suitable type of battery charging circuit. In some embodiments of the disclosed concept, the charging unit 50 is a float charger. However, it is contemplated that other types of suitable battery charging circuits may be employed without departing from the scope of the disclosed concept.

The battery 60 is electrically connected to the charging unit 50. The battery 60 may be any suitable type of rechargeable battery.

The heater 70 is electrically connected to the selection circuit 30 and is disposed proximate to the battery 60. The heater 70 is structured to use the harvested energy received from the selection circuit 30 to generate heat. In some embodiments of the disclosed concept, the heater 70 is a resistive heater that includes a resistive load (Load A 72). When the harvested energy passes through the resistive load, the heater 70 generates heat. In some embodiments of the disclosed concept, the heater 70 is a flexible resistive heater (e.g., without limitation, a flexible silicon resistor). The flexibility of a flexible resistive heater allows it to conform to the shape of the battery 60. It is contemplated that the heater 70 may be a separate product than the battery 60. It is also contemplated that the functionality of the heater 70 may be incorporated into the battery 60 so that the battery 60 and heater 70 are integrated into a single product.

The control unit 40 includes a selection control module 42 that is structured to control the selection circuit 30 to switch between electrically connected the source of harvested energy 26 to the charging unit 50 and electrically connecting the source of harvested energy 26 to the heater 70. It is contemplated that in some embodiments of the disclosed concept, the control unit 40 may include or be embodied in a processor apparatus/module that includes a processor and a memory. The processor may be, for example and without limitation, a microprocessor, a microcontroller, or some other suitable processing device or circuitry, that interfaces with the memory. The memory can be any of one or more of a variety of types of internal and/or external storage media such as, without limitation, RAM, ROM, EPROM(s), EEPROM(s), FLASH, and the like that provide a storage register, i.e., a machine readable medium, for data storage such as in the fashion of an internal storage area of a computer, and can be volatile memory or nonvolatile memory. The memory may include one or more routines stored therein that are executable by the processor to implement operation of the control unit 40.

In some example embodiments of the disclosed concept, the control unit 40 controls the selection circuit 30 to switch between electrically connecting the source of harvested energy 26 to the charging unit 50 and electrically connecting the source of harvested energy 26 to the heater 70 at a selected duty cycle (e.g., without limitation, 30% of the time heating and 70% of the time charging). In other words, over a selected period of time, the control unit 40 controls the selection circuit 30 to electrically connect the source of harvested energy 26 to the heater 70 for a percentage of the period of time and to electrically connect the source of harvested energy to the charging unit 50 the remainder of the period of time.

The control unit 40 may select the duty cycle based on input from one or more different sensors such as a current sensor 80 that senses the magnitude of the line current 10, an external temperature sensor 82 that senses the temperature outside the battery heating system 1, and a battery charging status sensor 84 that senses whether the batter 70 is charging or discharging. It is contemplated that the battery charging status sensor 84 may be a coulomb counter and/or a voltage monitoring circuit.

The magnitude of the line current 10 is proportional to the amount of harvested energy, which in turn is proportional to the amount of heat generated by the heater 70. Thus, when the line current 10 increases, the duty cycle may be changed to lower the percentage of time dedicated to heating, and thus reduce the risk of overheating the battery 60.

The temperature outside the battery heating system 1 indicates how much the battery 60 needs to be heated above the outside temperature, if at all. As the outside temperature drops, the duty cycle may be changed to increase the percentage of time dedicated to heating.

The battery charging status sensor 84 indicates whether the battery 60 is charging or discharging. When the battery 60 is discharging, rather than charging, it is an indication that the battery 60 temperature is possibly too low and the battery 60 may be in a state where it will not accept charge. In this condition, the duty cycle may be changed to increase the amount of time dedicated to heating in order to bring the battery 60 up to a temperature where it will accept a charge. As the battery 60 is heated and reaches a temperature where it accepts a charge, the state of charge will change from discharging to charging. At this point, the duty cycle may be changed to decrease the percentage of time dedicated to heating, and consequentially increase the percentage of time dedicated to charging in order charge the battery 60.

The control unit 40 may also consider the voltage of the battery 60 when selecting the duty cycle. In some example embodiments of the disclosed concept, the control unit 40 determines the duty cycle based on the state of charge of the battery 60 and the voltage of the battery 60. When the battery 60 stops charging, but its voltage is at a maximum voltage for the battery 60, it is an indication that the battery 60 is fully charged, rather than at a low temperature. In this case, the control unit 40 does not need to select a duty cycle directed at heating the battery 60. On the other hand, when the battery 60 is discharging and its voltage is below the maximum voltage for the battery 60, it is an indication that the battery 60 needs to be heated. In this case, the control unit 40 may select a duty cycle directed at heating the battery 60.

By electrically connecting the source of harvested energy 26 to the heater 70 at a selected duty cycle, rather than continuously, it is less likely that the heater 70 will cause the battery 60 to overheat. Moreover, changing the selected duty cycle based on characteristics such as the magnitude of the line current 10, the temperature outside the battery heating system 1 sensed by the external temperature sensor 82, and the state of charge of the battery 60 sensed by the battery charge status sensor 84 ensures that the heater 70 will not cause the battery 60 to overheat and does not require a temperature sensor that senses the temperature of the battery 60 itself. Determination of which duty cycles to use may be determined theoretically or experimentally.

The power supply 20 is generally going to continuously harvest energy from the power source 10. As such, if the battery 60 were in a condition where it will no longer accept charge, the harvested energy would need to be dissipated. When the harvested energy is provided to the heater 70, rather than simply being dissipated, the harvested energy is put to use rather than being wasted.

Referring to FIG. 2, a battery heating system 1′ in accordance with another example embodiment of the disclosed concept is shown. The battery heating system 1′ of FIG. 2 is similar to the battery heating system 1 of FIG. 1. However, in the battery heating system 1′ of FIG. 2, the heater 70′ includes multiple resistive loads (Load A 72, Load B 74, and Load C 76). Each resistive load has a different resistance (e.g., without limitation, 75Ω, 120Ω, 600Ω, etc.). Although a heater 70′ including three resistive loads is shown in FIG. 2, it is contemplated that the heater 70′ may include any number of resistive loads without departing from the scope of the disclosed concept.

The control unit 40′ includes a heater load control module 44 that is structured to select which one of the resistive loads of the heater 70′ to activate. When a resistive load is activate, the harvested energy is able to be provided to it when the source of harvested energy 26 is electrically connected to the heater 70′. The control unit 40′ is structured to select which resistive load in the heater 70′ to activate based on the magnitude of the line current 10, which may be obtained from the current sensor 80. A range of magnitude of the line current 10 is associated with each resistive load of the heater 70′. As the magnitude of the line current 10 rises, a resistive load having a lower resistance is selected.

In one example embodiment of the disclosed concept, the heater 70′ includes resistive loads of 75Ω, 120Ω, 600Ω. The control unit 40′ is structured to activate the 600Ω resistive load when the line current 10 is in a range from 0 A to about 100 A, to activate the 120Ω resistive load when the line current 10 is in a range from about 100 A to about 350 A, and to activate the 600Ω resistive load when the line current 10 is greater than about 350 A.

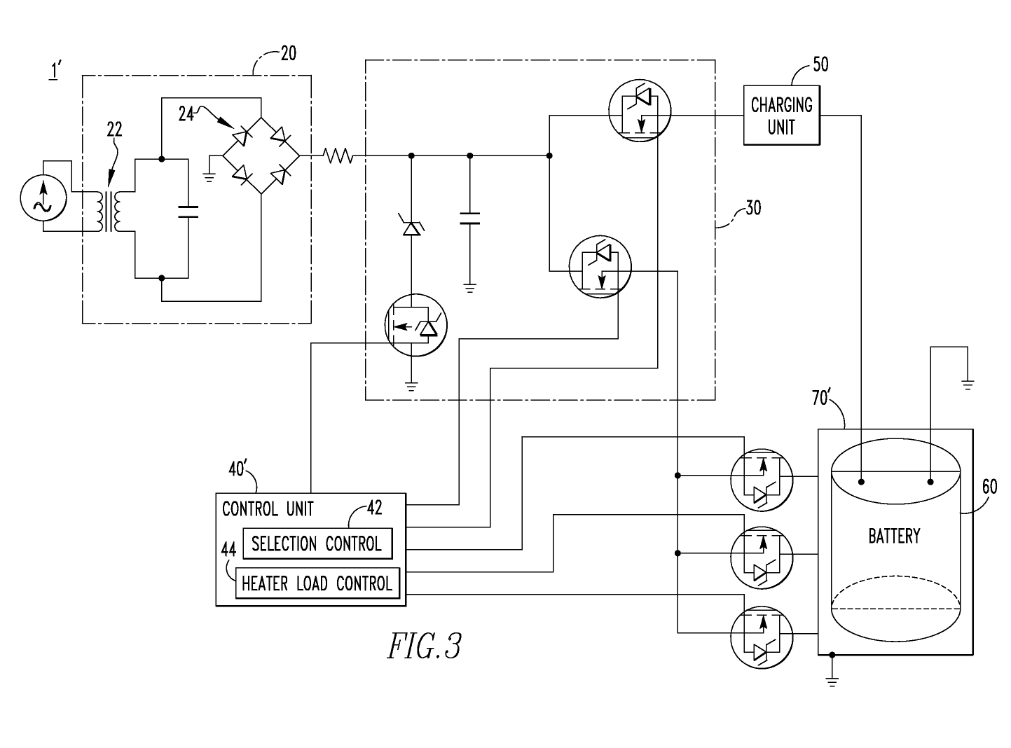

Referring to FIG. 3, a circuit diagram of the battery heating system 1′ of FIG. 2 is shown. The current sensor 80, the external temperature sensor 82, and the battery charging status sensor 84 are not shown in FIG. 3 for simplicity of illustration. As shown in FIG. 3, the rectifier 24 may be a bridge rectifier. Also, as shown in FIG. 3, the selection circuit 30 may include electrically controlled switches, such as transistors, which allow selection between providing the harvested energy to the charging unit 50 or to the heater 70′. Additionally, the electrically controlled switches may be electrically connected between the selection circuit 30 and the heater 70′ to allow for selection of which resistive load of the heater 70′ to activate. The state of the electrically controlled switches is controlled by the control unit 40′.

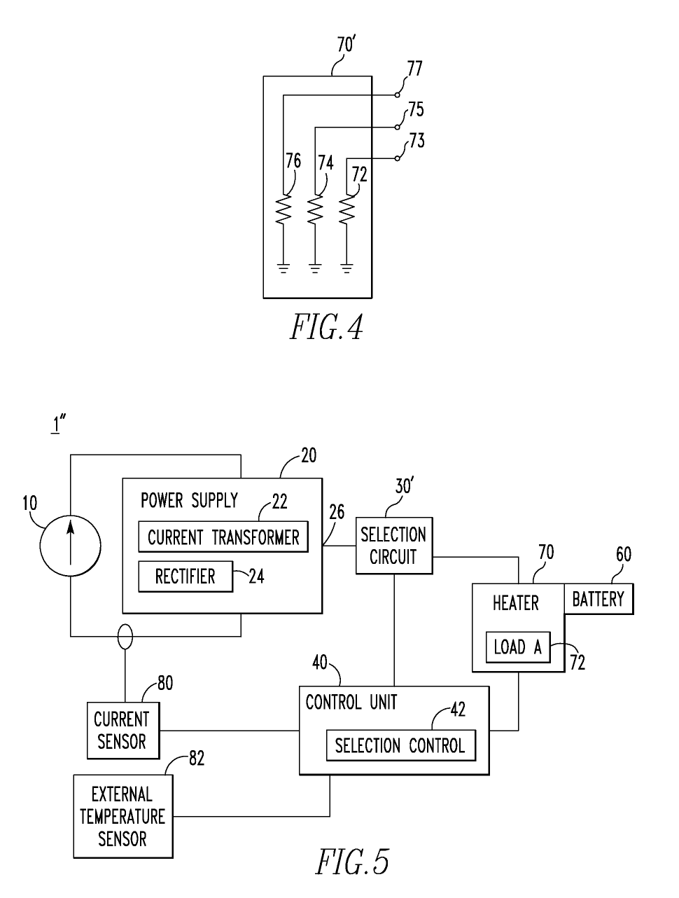

FIG. 4 is a circuit diagram of the battery 70′ of FIGS. 2 and 3. As shown in FIG. 4, the battery 70′ includes multiple resistive loads 72,74,76. Each of the resistive loads 72,74,76 has an associated terminal 73,75,77. The harvested energy is provided at the terminal 73,75,77 corresponding to the activated resistive load when the source of harvested energy 26 is electrically connected to the heater 70′.

Turning to FIG. 5, a battery heating system 1″ in accordance with another example embodiment of the disclosed concept is shown. The battery heating system 1″ of FIG. 5 is similar to the battery heating system 1 of FIG. 1. However, the battery heating system 1″ of FIG. 5 does not include a charging unit 50. In this case, the battery 60 may be a non-rechargeable battery. Even though the battery 60 may be a non-rechargeable battery, there may still be a need to heat the battery 60.

In the battery heating system 1″ of FIG. 5, the selection circuit 30′ is structured to either electrically connect the source of harvested energy 26 to the heater 70 or to electrically disconnect the source of harvested energy 26 from the heater 70. The control unit 40 controls the selection circuit 30′ to either electrically connect the source of harvested energy 26 to the heater 70 or to electrically disconnect the source of harvested energy 26 from to the heater 70. The control unit 40 may control the selection circuit 30′ to electrically connect the source of harvested energy 26 to the heater 70 at a selected duty cycle (e.g., 70% of the time providing the harvested energy and 30% of the time not providing the harvested energy). The control unit 40 may select the duty cycle based on one or more characteristics such as the magnitude of the line current 10 and the temperature outside the battery heating system 1″ as sensed by the external temperature sensor 82.

It will be appreciated that the charging circuit 50 may similarly be omitted from the example embodiment shown in FIG. 2 without departing from the scope of the disclosed concept.

Although the disclosed concept has been described in relation to batteries, it is contemplated that the disclosed concept may also be employed with other suitable types of energy storage devices such as, without limitation, super capacitors.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. An energy storage device heating system comprising:
an energy storage device;
a power supply structured to generate a source of harvested energy by harvesting energy from a power source;
a heater disposed proximate to the energy storage device and structured to use the harvested energy to generate heat;
a charging unit structured to use the harvested energy to charge the energy storage device;
a selection circuit structured to selectively electrically connect the source of harvested energy to the charging unit or the heater; and
a control unit including a selection control module structured to control the selection circuit to switch between electrically connecting the source of harvested energy to the charging unit and electrically connecting the source of harvested energy to the heater.

2. The energy storage device heating system of claim 1, wherein the power source is a line current; and wherein the power supply includes a current transformer to harvest energy from the line current and a rectifier to rectify the harvested energy.

3. The energy storage device heating system of claim 2, wherein the rectifier is a bridge rectifier.

4. The energy storage device heating system of claim 1, wherein the selection circuit includes a number of electrically controlled switches structured to electrically connect the source of harvested energy to the charging unit or the heater; and wherein a state of the electrically controlled switches is controlled by the control unit.

5. The energy storage device heating system of claim 4, wherein the electrically controlled switches are transistors.

6. The energy storage device heating system of claim 1, wherein the charging unit is a float charger.

7. The energy storage device heating system of claim 1, wherein over a selected period of time, the control unit is structured to control the selection circuit to electrically connect the source of harvested energy to the heater a first percentage of the period of time and to control the selection circuit to electrically connect the source of harvested energy to the charging unit the remainder of the period of time.

8. The energy storage device heating system of claim 7, wherein the control unit is structured to select the first percentage based on at least one of a current of the power source, a temperature outside the energy storage device heating system, and a state of charge of the energy storage device.

9. The energy storage device heating system of claim 1, wherein the heater includes a resistive load; and wherein providing the harvested energy to the resistive load generates heat.

10. The energy storage device heating system of claim 1, wherein the heater includes a plurality of resistive loads; wherein the control unit includes a heater load control module structured to activate a selected one of the resistive loads to provide harvested energy to.

11. The energy storage device heating system of claim 10, wherein the selected one of the resistive loads is activated based on a current of the power source.

12. The energy storage device heating system of claim 10, wherein the heater includes a first resistive load, a second resistive load, and a third resistive load; wherein the control unit activates the first resistive load when a magnitude of a current of the power source is within a first range; wherein the control unit activates the second resistive load when the magnitude of the current of the power source is within a second range; wherein the control unit activates the third resistive load when the magnitude of the current of the power source is within a third range; wherein magnitudes in the third range are greater than magnitudes in the second range and magnitudes in the second range are greater than magnitudes in the first range; and wherein a resistance of the first resistive load is greater than a resistance of the second resistive load and a resistance of the second resistive load is greater than a resistance of the third resistive load.

13. The energy storage device heating system of claim 1, wherein the energy storage device is a rechargeable battery.

14. An energy storage device heating system comprising:
an energy storage device;
a power supply structured to generate a source of harvested energy by harvesting energy from a power source;
a heater disposed proximate to the energy storage device and structured to use the harvested energy to generate heat;
a selection circuit structured to selectively electrically connect the source of harvested energy to the heater or to disconnect the source of harvested energy from the heater; and
a control unit including a selection control module structured to control the selection circuit to switch between electrically connected the source of harvested energy to the heater unit and electrically disconnecting the source of harvested energy from the heater.

15. The energy storage device heating system of claim 14, wherein over a selected period of time, the control unit is structured to control the selection circuit to electrically connect the source of harvested energy to the heater a first percentage of the period of time and to control the selection circuit to electrically disconnect the harvested energy from the heater the remainder of the period of time.

16. The energy storage device heating system of claim 15, wherein the control unit selects the first percentage based on at least one of a current of the power source and a temperature outside the energy storage device heating system.

17. The energy storage device heating system of claim 14, wherein the energy storage device is a non-rechargeable battery or a super capacitor.

18. A method of heating an energy storage device, the method comprising:
creating a source of harvested energy by harvesting energy from a power source; and
for a selected period of time, electrically connecting the source of harvested energy a heater to heat the energy storage device for a first percentage of the selected period of time and electrically connecting the source of harvested energy to a charging unit to charge the energy storage device the remainder of the selected period of time.

19. The method of claim 18, wherein the first percentage is based on at least one of a current of the power source, an outside temperature, and a state of charge of the energy storage device.

20. The method of claim 18, wherein the heater includes a plurality of restive loads; and wherein the method further comprises:
activating a selected one of the resistive loads based on a current of the power source; and
electrically connecting the source of the harvested energy to the activated resistive load.
